(19) United States
(12) Patent Application Publication
(10) Pub. No.: US 2002/0000679 A1
(43) Pub. Date: Jan. 3, 2002

(54) Method and device for producing thick lenses of plastic material

(76) Inventor: Andrea Fallini, Legnano (IT)

Correspondence Address: Douglas W. Swartz, SHERIDAN ROSS P.C., Suite 1200, 1560 Broadway, Denver, CO, 80202-5141, US

(21) Appl. No.: 09/834,754

(22) Filed: Apr. 12, 2001

(30) Foreign Application Priority Data
Apr. 13, 2000 (IT) MI2000A000822

(51) Int. Cl. B29D 11/00; B29C 45/00

(52) U.S. Cl. 264/1.1; 264/328.15; 425/549; 425/566

(57) ABSTRACT

To produce thick lenses of plastic material, a mold is first prepared having an inner cavity corresponding in shape to the lens for molding and having a work surface corresponding to an optical surface of the lens for molding; and liquid plastic material is then injected into the cavity of the mold. According to the invention, the injection is effected at a geometric center of the work surface and in a direction substantially perpendicular to the work surface, i.e. substantially along an optical axis of the lens for molding.

The present invention relates to a method and device for producing thick lenses of plastic material.

### BACKGROUND OF THE INVENTION

As is known, numerous devices, including vehicle headlamps, comprise a light source and a lens for correctly orienting the beam emitted by the source; and many applications, such as motor vehicles, call for thick lenses with superior optical characteristics normally only be obtainable from glass lenses, which, however, are extremely heavy and relatively expensive and difficult to produce.

On the other hand, known methods of producing plastic lenses fail to provide for lenses which are both relatively thick and have high-quality optical surfaces. Thick plastic lenses, in fact, are injection molded by feeding a suitable plastic material into a mold comprising two half-molds defining a cavity of the same shape as the lens for molding. In known solutions, the injection channel is formed between the two half-molds, lies substantially in the plane of the lens for molding (perpendicular to the optical axis of the lens), and terminates at a lateral edge of the mold cavity, so that the material is injected at the peripheral edge of the lens (so-called direct injection). Particularly when dealing with thick lenses, this type of solution leads to the formation of air pockets and surface defects which impair the quality of the optical surfaces of the lens, and which are mainly due to the way the plastic material cools inside the mold. As it cools, in tact, the material shrinks considerably so that the molding may be smaller than or differ in shape from the mold cavity. To partly compensate for shrinkage of the material, additional liquid material is normally fed into the mold at the hold stage.

It, however, the material is injected, as currently, along the thin peripheral edge of the lens, the material in this region sets faster than in the thicker regions (particularly the center of the lens); and, once the edge of the lens has set, no more material can be fed into the mold to compensate for thermal shrinkage, and the material shrinks considerably, thus deforming the optical surfaces and/or forming air pockets (voids) inside the body of the lens. The problem is further compounded by the material already beginning to cool inside the injection channel, which, in known solutions, has no heating elements.

One known variation of plastic lens injection molding technology—in this case, relative to double-concave lenses—is described in U.S. Pat. No. 4,560,342: the injection channel is still formed between the two half-molds, is substantially perpendicular to the optical axis of the lens for molding, and is connected to the peripheral edge of the cavity defining the lens mold, but, in this case, is movable substantially into the center of the cavity to produce lenses with substantially no joint lines. The drawbacks mentioned relative to cooling of the material inside the mold, however, still remain, and the equipment, requiring a movable injection channel, is obviously extremely complex and expensive to produce and operate.

### SUMMARY OF THE INVENTION

It is therefore an object of the present invention to provide a method and device for producing thick plastic lenses, designed to eliminate the aforementioned drawbacks, and which, in particular, provide in a straightforward, low-cost manner for obtaining plastic lenses which are both relatively thick and have superior optical characteristics by being substantially free of defects.

According to the present invention, there is provided a method of producing thick lenses of plastic material, in particular lenses having a diameter to thickness ratio of less than about 10, and comprising the steps of:

preparing a mold having an inner cavity corresponding in shape to the lens for molding and having a first work surface corresponding to a first optical surface of said lens; and

effecting an injection of liquid plastic material into said cavity of the mold;

the method being characterized in that said injection of liquid plastic material is effected at a geometric center of said first work surface and in a direction substantially perpendicular to said first work surface.

The invention also relates to a device for producing thick lenses of plastic material, in particular lenses having a diameter to thickness ratio of less than about 10, and comprising a mold having an inner cavity corresponding in shape to the lens for molding, and an injection channel for feeding liquid plastic material into said cavity; an end wall of said cavity having a first work surface corresponding to a first optical surface of said lens; and the device being characterized in that said injection channel is formed through said end wall of said cavity, is substantially perpendicular to said first work surface, and communicates with said cavity through an injection hole located at the geometric center of said work surface.

The invention therefore provides in a straightforward, low-cost manner for obtaining thick lenses of plastic material with excellent optical characteristics: injecting the material at the center of the optical surface not only prevents the feed region from setting before the mold is filled, but also provides for optimum distribution of the material, thus ensuring uniform cooling with no defects.

### BRIEF DESCRIPTION OF THE DRAWINGS

A number of non-limiting embodiments of the present invention will be described by way of example with reference to the accompanying drawings, in which:

FIG. 1 shows a highly schematic section of a device for producing thick lenses of plastic material in accordance with the invention, and illustrated in the performance of a first step in the method according to the invention;

FIG. 2 shows the FIG. 1 device in the course of a second step in the method according to the invention.

### DETAILED DESCRIPTION OF THE INVENTION

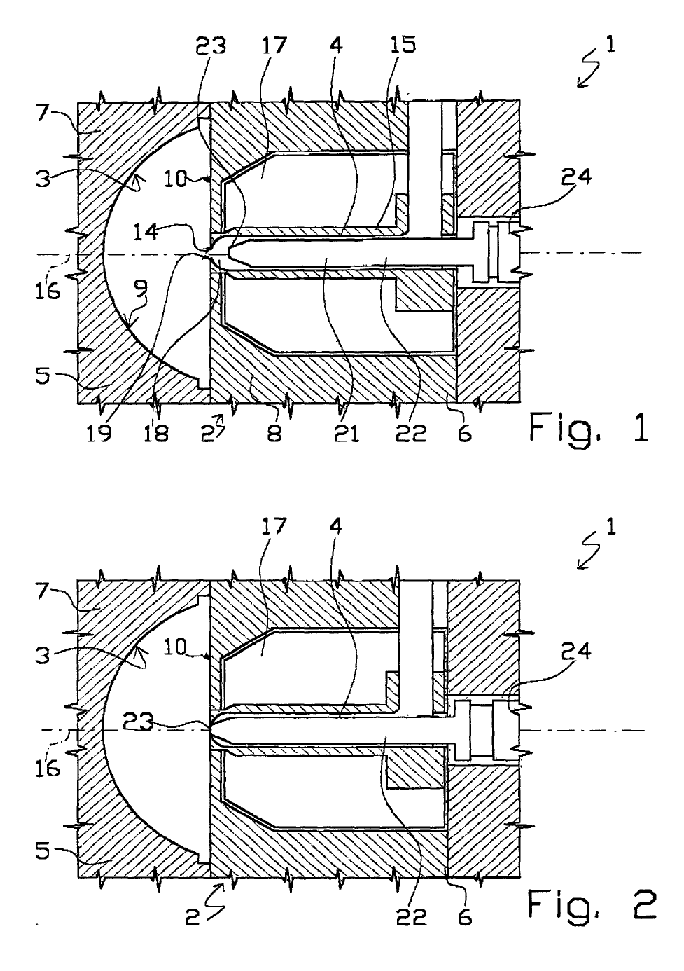

Number 1 in FIG. 1 indicates as a whole a device for producing thick lenses of plastic material. AB is known, “thick lenses” is the term generally applied to lenses with a diameter to thickness ratio of less than about 10, and which, in the automotive industry, is normally less than about 4.

Device 1 comprises a mold 2 having an inner cavity 3 corresponding in shape to the lens for molding; and an injection channel 4 for feeding liquid plastic material into cavity 3. Mold 2 comprises two portions or half-molds 5, 6 movable (in known manner) with respect to each other and connectable to define cavity 3 when mold 2 is closed. Cavity 3 has two opposite end walls 7, 8 carried respectively by half-molds 5, 6 and having respective inner work surfaces 9, 10, which are respectively concave and substantially flat, and correspond to respective optical surfaces of the lens for molding (which, in the non-limiting example shown, is therefore a planoconvex lens defined by a convex optical surface and a substantially plane optical surface). Half-molds 5, 6 mate along work surface 10.

At a geometric center of work surface 10 (which has for example a circular shape), end wall 8 has an injection hole 14 formed through end wall 8 itself. Injection channel 4 is formed in a body 15 housed inside hale-mold 6; extends through end wall 8; communicates with cavity 3 through injection hole 14; is substantially perpendicular to work surface 10 and parallel to an optical axis 16 of the lens for molding (with its longitudinal axis substantially coincident with optical axis 16); is connected in known manner to a known injection press not shown; has known heating means 17 not shown or described in detail for the sake of simplicity; and comprises an end nozzle 18, which communicates with cavity 3 through injection hole 14, is housed inside end wall 8, has a section converging towards cavity 3, and terminates with an end edge 19 substantially flush with work surface 10, so that injection channel 4 is entirely outside cavity 3.

Injection channel 4 also has movable plugging means 21 for selectively closing injection hole 14, and which may be of any known type, e.g. comprising a pin plug 22 sliding axially inside injection channel 4 up to end nozzle 18 and having a head 23 insertable inside injection hole 14, flush with work surface 10, to restore the continuity of work surface 10. The sliding movement of pin plug 22 is controlled by known actuating means 24 (shown schematically in FIG. 1).

With reference also to FIG. 2, in which any details similar to or identical with those already described are indicated using the same reference numbers, device 1 for implementing the method of producing thick lenses of plastic material according to the invention operates as follows.

First of all, mold 2 is formed with a cavity 3 of the desired shape, corresponding to the lens for molding and having, in particular, a work surface 10 corresponding to an optical surface of the lens. Half-molds 5, 6 are mated to close mold 2, and a given quantity, sufficient to fill cavity 3, of a liquid plastic material at a predetermined temperature is injected into cavity 3. By virtue of the particular configuration of device 1, the liquid plastic material is injected into mold 2 at the geometric center of work surface 10 and in a direction substantially perpendicular to work surface 10 and therefore perpendicular to the plane (and to the optical surfaces) of the lens for molding. More specifically, the injection direction is substantially coincident with optical axis 16 of the lens for molding.

As shown in FIG. 1, during injection, injection hole 14 is open, by pin plug 22 being withdrawn to allow the material to flow from injection channel 4 to injection hole 14 and into cavity 3. During injection, injection channel 4 is heated (by heating means 17) to a given temperature such as to prevent the plastic material from setting inside injection channel 4.

Once the liquid plastic material is injected into mold 2 (including any material injected to compensate for thermal shrinkage), pin plug 22 is moved by actuating means 24 into an extracted position (FIG. 2) in which head 23 is inserted inside injection hole 14, flush with work surface 10, to restore the continuity of work surface 10. This is then followed by a cooling step in which the plastic material inside mold 2 is set.

Half-molds 5, 6 are then parted to open mold 2, and the lens is extracted from cavity 3.

Clearly, changes may be made to the method and device as described and illustrated herein without, however, departing from the scope of the present invention.

In particular, though reference is made to lenses having a convex optical surface and a substantially plane optical surface, the method and device according to the invention obviously also apply to other types of lenses.

1. A method of producing thick lenses of plastic material, in particular lenses having a diameter to thickness ratio of less than about 10, and comprising the steps of:
preparing a mold (2) having an inner cavity (3) corresponding in shape to the lens for molding and having a first work surface (10) corresponding to a first optical surface of said lens; and
effecting an injection of liquid plastic material into said cavity (3) of the mold (2);
the method being characterized in that said injection of liquid plastic material is effected at a geometric center of said first work surface (10) and in a direction substantially perpendicular to said first work surface (10).

2. A method as claimed in claim 1, characterized in that said injection is performed by means of an injection channel (4) completely outside said cavity (3) and having an end nozzle (18) communicating with said cavity (3) and in turn having an end edge (19) flush with said first work surface (10).

3. A method as claimed in claim 2, characterized in that said injection is performed by means of an injection channel (4) heated to and maintained at a predetermined temperature such as to prevent said plastic material from setting in said injection channel (4).

4. A method as claimed in claim 3, characterized by also comprising, after said injection of liquid plastic material into the mold (2), a step of closing said injection channel (4) and restoring the continuity of said first work surface (10); and a step of cooling the plastic material in the mold (2) to cause said plastic material to set.

5. A device (1) for producing thick lenses of plastic material, in particular lenses having a diameter to thickness ratio of less than about 10, and comprising a mold (2) having an inner cavity (3) corresponding in shape to the lens for molding, and an injection channel (4) for feeding liquid plastic material into said cavity (3); an end wall (8) of said cavity (3) having a first work surface (10) corresponding to a first optical surface of said lens; and the device being characterized in that said injection channel (4) is formed through said end wall (8) of said cavity (3), is substantially perpendicular to said first work surface (10), and communicates with said cavity (3) through an injection hole (14) located at the geometric center of said work surface (14).

6. A device as claimed in claim 1, characterized in that said injection channel (4) is completely outside said cavity (3) and has an end nozzle (18) communicating with said cavity (3) through said injection hole (14) and located inside said end wall (8) with an end edge (19) of the nozzle substantially flush with said first work surface (10).

7. A device as claimed in claim 1, characterized in that said injection channel (4) has heating means (17) for maintaining the plastic material fed along said injection channel (4) at a predetermined temperature such as to prevent said plastic material from setting in said injection channel (4).

8. A device as claimed in claim 1, characterized in that said injection channel (4) has movable plugging means (21) for selectively closing said injection hole (14).

9. A device as claimed in claim 1, characterized in that said movable plugging means (21) comprise a pin plug (22) sliding axially inside said end nozzle (18), and actuating means (24) for moving said pin plug (22) axially; said pin plug having a head (23) insertable inside said injection hole (14), flush with said first work surface (10), to restore the continuity of said first work surface (10).
